(19) United States
(12) Patent Application Publication
(10) Pub. No.: US 2017/0187154 A1
(43) Pub. Date: Jun. 29, 2017

(54) APPARATUS CONFIGURED TO PROVIDE TO A LIGHT SOCKET, A POWER OUTLET FOR A CONSUMER ELECTRONICS DEVICE

(71) Applicant: Nemo Ventures, LLC, Overland Park, KS (US)

(72) Inventors: Paul Edward Skelton, Kansas City, MO (US); Robert S. Cutler, Leawood, KS (US)

(73) Assignee: Nemo Ventures, LLC

(21) Appl. No.: 15/461,256

(22) Filed: Mar. 16, 2017

Related U.S. Application Data
(62) Division of application No. 14/247,090, filed on Apr. 7, 2014.

(51) Int. Cl. H01R 27/00; H01R 31/06; H02J 7/00; H04R 1/02; F21V 23/04; H05B 37/02; H01R 31/02; H01R 13/70

(52) U.S. Cl. CPC H01R 27/00; H01R 31/02; H01R 31/06; H01R 13/701; H04R 1/028; F21V 23/0435; H05B 37/0281; H05B 37/0272; H02J 7/0045; H02J 7/0052; H04R 2420/07

(57) ABSTRACT

This disclosure describes an apparatus including a body, a connector base, a light source, and one or more power sockets. The body may be formed of an electrically insulating material. The connector base may be disposed on the body and configured to be inserted into a socket of a lamp or light fixture. The light source may be irremovably coupled with the body and configured such that electrical power from the lamp or light fixtures is provided to the light source. The one or more power sockets may be disposed on or within the body and may include a first power socket configured to receive a plug electrically coupled to a coupling consumer electronics device such that electrical power from the lamp or light fixture is provided to the consumer electronics device. The light source and the body may form a singular object.

### RELATED APPLICATIONS

This application is a divisional of U.S. application Ser. No. 14/247,090, filed Apr. 7, 2014 and entitled “APPARATUS CONFIGURED TO PROVIDE TO A LIGHT SOCKET, A POWER OUTLET FOR A CONSUMER ELECTRONICS DEVICE,” all of which is incorporated herein by reference in its entirety.

### FIELD OF THE DISCLOSURE

This disclosure relates an apparatus configured to provide to a light socket, a power outlet for a consumer electronics device.

### BACKGROUND

A consumer electronics device (e.g., a Smartphone, a tablet, a portable music player, and/or other devices) is typically charged via a charging cord that electrically couples the device to a power supply. The charging cord may be plugged into a wall outlet serving as the power supply. Wall outlets may often be located in hard-to-reach places (e.g., behind furniture) or at locations far from where a user would like to have the device be accessible.

### SUMMARY

Exemplary implementations provide an apparatus configured to allow a consumer electronics device to be charged by a lamp or a light fixture. This may be particularly appealing when a user prefers to have the consumer electronics device be accessible during the night. For example, the user may wish to have the consumer electronics device placed on a bed stand near where the user sleeps. Wall outlets may be located behind the bed stand or bed, or otherwise be inconveniently located relative to the bed stand. By being able to plug the consumer electronics device into an outlet provided by the apparatus at a lamp on the bed stand, the user may conveniently charge the consumer electronics device while they sleep.

One aspect of the disclosure relates to an apparatus configured to provide to a light socket, a power outlet for a consumer electronics device. The apparatus may comprise a body, a connector base, a light bulb socket, and one or more power sockets. The body may be formed of an electrically insulating material. The connector base may be disposed on the body. The connector base may be configured to be inserted into a socket of a lamp or light fixture to provide an electrical connection between the apparatus and the lamp or light fixture. The light bulb socket may be disposed on or within the body. The light bulb socket may be configured to receive a light bulb such that electrical power from the lamp or light fixtures is provided to the light bulb. The one or more power sockets may be disposed on or within the body. The one or more sockets may include a first power socket. The first power socket may be configured to receive a plug electrically coupled to a coupling consumer electronics device such that electrical power from the lamp or light fixture is provided to the consumer electronics device.

Another aspect of the disclosure relates to an apparatus configured to provide to a light socket, a power outlet for a consumer electronics device. The apparatus may comprise a body, a connector base, a light source, and one or more power sockets. The body may be formed of an electrically insulating material. The connector base may be disposed on the body. The connector base may be configured to be inserted into a socket of a lamp or light fixture to provide an electrical connection between the apparatus and the lamp or light fixture. The light source may be disposed on the body. The light source may be electrically coupled with the connector base such that electrical power from the lamp or light fixtures is provided to the light source. The one or more power sockets may be disposed on or within the body. The one or more sockets may include a first power socket. The first power socket may be configured to receive a plug electrically coupled to a coupling consumer electronics device such that electrical power from the lamp or light fixture is provided to the consumer electronics device.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an apparatus configured to provide to a light bulb socket, a power outlet for a consumer electronics device, in accordance with one or more implementations.

FIG. 2A illustrates a perspective view of a first exemplary implementation of an apparatus configured to provide to a light bulb socket, a power socket outlet for a consumer electronics device.

FIG. 2B illustrates a front elevation view of the first exemplary implementation presented in FIG. 2A, which is a mirror image of a back elevation view.

FIG. 2C illustrates a right-side elevation view of the first exemplary implementation presented in FIG. 2A.

FIG. 2D illustrates a left-side elevation view of the first exemplary implementation presented in FIG. 2A.

FIG. 2E illustrates a top plan view of the first exemplary implementation presented in FIG. 2A.

FIG. 2F illustrates a bottom plan view of the first exemplary implementation presented in FIG. 2A.

FIG. 2G illustrates a sectional view along section A-A (see FIGS. 2E and 2F) of the first exemplary implementation presented in FIG. 2A.

FIG. 3A illustrates a perspective view of a second exemplary implementation of an apparatus configured to provide to a light bulb socket, a power socket outlet for a consumer electronics device.

FIG. 3B illustrates a front elevation view of the second exemplary implementation presented in FIG. 3A, which is a mirror image of a back elevation view.

FIG. 3C illustrates a right-side elevation view of the second exemplary implementation presented in FIG. 3A.

FIG. 3D illustrates a left-side elevation view of the second exemplary implementation presented in FIG. 3A.

FIG. 3E illustrates a top plan view of the second exemplary implementation presented in FIG. 3A.

FIG. 3F illustrates a bottom plan view of the second exemplary implementation presented in FIG. 3A.

FIG. 3G illustrates a sectional view along section B-B (see FIGS. 3E and 3F) of the second exemplary implementation presented in FIG. 3A.

FIG. 4A illustrates a perspective view of a fourth exemplary implementation of an apparatus configured to provide to a light bulb, a power socket outlet for a consumer electronics device.

FIG. 4B illustrates a front elevation view of the fourth exemplary implementation presented in FIG. 4A, which is a mirror image of a back elevation view.

FIG. 4C illustrates a right-side elevation view of the fourth exemplary implementation presented in FIG. 4A.

FIG. 4D illustrates a left-side elevation view of the fourth exemplary implementation presented in FIG. 4A.

FIG. 4E illustrates a top plan view of the fourth exemplary implementation presented in FIG. 4A.

FIG. 4F illustrates a bottom plan view of the fourth exemplary implementation presented in FIG. 4A.

FIG. 4G illustrates a perspective view of the fourth exemplary implementation presented in FIG. 4A with some portions being shown as transparent.

FIG. 5A illustrates a perspective view of a fourth exemplary implementation of an apparatus configured to provide to a light bulb, a power socket outlet for a consumer electronics device.

FIG. 5B illustrates a front elevation view of the fourth exemplary implementation presented in FIG. 5A, which is a mirror image of a back elevation view.

FIG. 5C illustrates a right-side elevation view of the fourth exemplary implementation presented in FIG. 5A.

FIG. 5D illustrates a left-side elevation view of the fourth exemplary implementation presented in FIG. 5A.

FIG. 5E illustrates a top plan view of the fourth exemplary implementation presented in FIG. 5A.

FIG. 5F illustrates a bottom plan view of the fourth exemplary implementation presented in FIG. 5A.

FIG. 5G illustrates a perspective view of the fourth exemplary implementation presented in FIG. 5A with some portions being shown as transparent.

FIG. 6A illustrates a perspective view of a fifth exemplary implementation of an apparatus configured to provide to a light bulb, a power socket outlet for a consumer electronics device.

FIG. 6B illustrates a front elevation view of the fifth exemplary implementation presented in FIG. 6A, which is a mirror image of a back elevation view.

FIG. 6C illustrates a right-side elevation view of the fifth exemplary implementation presented in FIG. 6A.

FIG. 6D illustrates a left-side elevation view of the fifth exemplary implementation presented in FIG. 6A.

FIG. 6E illustrates a top plan view of the fifth exemplary implementation presented in FIG. 6A.

FIG. 6F illustrates a bottom plan view of the fifth exemplary implementation presented in FIG. 6A.

FIG. 6G illustrates a perspective view of the fifth exemplary implementation presented in FIG. 6A with some portions being shown as transparent.

FIG. 7A illustrates a perspective view of the sixth exemplary implementation of an apparatus configured to provide to a light bulb, a power socket outlet for a consumer electronics device.

FIG. 7B illustrates a front elevation view of the sixth exemplary implementation presented in FIG. 7A, which is a mirror image of a back elevation view.

FIG. 7C illustrates a right-side elevation view of the sixth exemplary implementation presented in FIG. 7A.

FIG. 7D illustrates a left-side elevation view of the sixth exemplary implementation presented in FIG. 7A.

FIG. 7E illustrates a top plan view of the sixth exemplary implementation presented in FIG. 7A.

FIG. 7F illustrates a bottom plan view of the sixth exemplary implementation presented in FIG. 7A.

FIG. 7G illustrates a perspective view of the sixth exemplary implementation presented in FIG. 7A with some portions being shown as transparent.

FIG. 8A illustrates a perspective view of the seventh exemplary implementation of an apparatus configured to provide to a light bulb, a power socket outlet for a consumer electronics device.

FIG. 8B illustrates a front elevation view of the seventh exemplary implementation presented in FIG. 8A, which is a mirror image of a back elevation view.

FIG. 8C illustrates a right-side elevation view of the seventh exemplary implementation presented in FIG. 8A.

FIG. 8D illustrates a left-side elevation view of the seventh exemplary implementation presented in FIG. 8A.

FIG. 8E illustrates a top plan view of the seventh exemplary implementation presented in FIG. 8A.

FIG. 8F illustrates a bottom plan view of the seventh exemplary implementation presented in FIG. 8A.

FIG. 8G illustrates a perspective view of the seventh exemplary implementation presented in FIG. 8A with some portions being shown as transparent.

### DETAILED DESCRIPTION

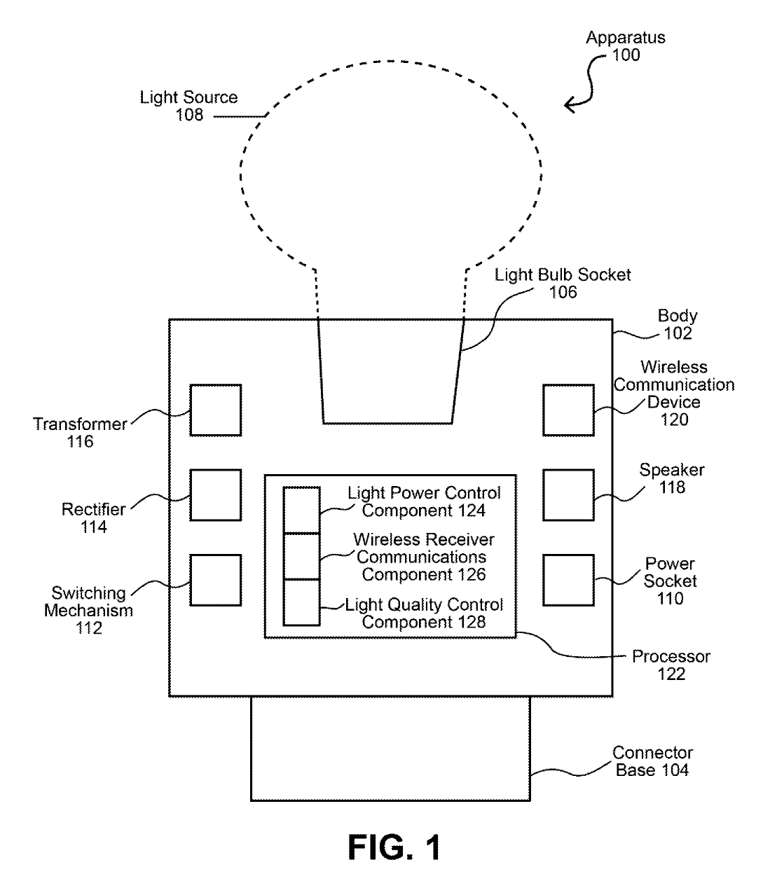

FIG. 1 illustrates an apparatus 100 configured to provide to a light bulb socket, a power outlet for a consumer electronics device, in accordance with one or more implementations. In some implementations, apparatus 100 may include one or more of a body 102, a connector base 104, a light bulb socket 106, a light bulb 108, one or more power sockets 110, a switching mechanism 112, a rectifier 114, a transformer 116, a power source 117, a speaker 118, a wireless communications device 120, one or more processors 122, and/or other components.

The body 102 may be formed of an electrically insulating material and/or a thermally insulating material. Examples of an electrically insulating material and/or a thermally insulating material may include one or more of a ceramic material, a polymeric material, and/or other insulating materials. The body 102 may be shaped to provide a grip for a user twisting apparatus 100 into a socket of a lamp or light fixture (not depicted).

The connector base 104 may be disposed on body 102. The connector base 104 may be configured to be inserted into a socket of a lamp or light fixture to provide an electrical connection between apparatus 100 and the lamp or light fixture. According to various implementations, connector base 104 may include one or more of an Edison screw base, a bayonet-style base, a bi-post base, a wedge base, a fluorescent tubular lamp base, and/or other types of connector bases configured to be inserted in to a socket of a lamp or light fixture.

The light bulb socket 106 may be disposed on or within body 102. The light bulb socket 106 may be configured to receive a light bulb (or other light source) such that electrical power from the lamp or light fixtures is provided to the light bulb. The light bulb socket 106 may be configured to receive a light bulb having a base that is an Edison screw base, a bayonet-style base, a bi-post base, a wedge base, a fluorescent tubular lamp base, and/or other types of light bulb bases. In some implementations, light bulb socket 106 may be permanently coupled to a light bulb (or other light source). In some implementations, apparatus 100 may be devoid of light bulb socket 106.

The light source 108 may be disposed on body 102. In some implementations, light source 108 and body 102 may be integrated as a singular object. The light source 108 may be electrically coupled with connector base 104 such that electrical power from the lamp or light fixtures is provided to light source 108. By way of non-limiting example, light source 108 may include one or more of an incandescent light bulb, a light emitting diode (LED), a fluorescent light bulb, and/or other light sources.

The power socket(s) 110 may be disposed on or within body 102. A given power socket 110 may be configured to receive a plug electrically coupled to a consumer electronics device (not depicted) such that electrical power from the lamp or light fixture is provided to the consumer electronics device. In some implementations, the given power socket 110 may be configured to transmit and/or receive information in addition to electrical power. The power socket(s) 110 may include one or more of a standard size USB socket, a mini size USB socket, a micro size USB socket, a FireWire socket, stereo jack, and/or other power sockets configured to receive a plug electrically coupled to a consumer electronics device.

The switching mechanism 112 may be configured to switch on and off electrical power provided to light bulb socket 106 while electrical power to one or more power socket(s) 110 is maintained on. In some implementations, switching mechanism 112 may include one or more of a pull-chain switch, a twist knob switch, a push button switch, a toggle switch, a rocker switch, a wireless switch, a touch-sensitive switch, a touchless motion sensor, and/or other types of switching mechanisms. According to some implementations, switching mechanism 112 may be communicatively coupled with a wall switch (not depicted) such that actuating the wall switch switches on and off electrical power provided to light bulb socket 106 while electrical power to one or more power socket(s) 110 is maintained on. Such a communicative coupling between switching mechanism 112 and the wall switch may include one or both of a wireless connection or a wired connection.

The rectifier 114 may be disposed within body 102. The rectifier 114 may be configured to transform alternating current received from the lamp or light fixture to direct current such that direct current is provided to one or more power socket(s) 110.

The transformer 116 may be disposed within body 102. The transformer 116 may be configured to step down a voltage received from the lamp or light fixture such that a reduced voltage is provided to one or more power socket(s) 110. For example, a voltage of 110 volts may be stepped down to five volts for a given power socket 110.

The power source 117 may be disposed within body 102. The power source 117 may be configured to store electrical power provided by a lamp or light fixture. The power source 117 may be configured to store excess power when it is available to apparatus 100. The power source 117 may be configured to provide stored power when power is unavailable to apparatus 100 from a lamp or light fixture. The power source 117 may be configured to provide electrical power to one or more components of apparatus 100 (e.g., light source 108, power socket 110, switching mechanism 112, speaker 118, wireless communications device 120, processor 122, and/or other components). In some implementations, power source 117 may include one or more of a rechargeable battery, a capacitor, and/or other power sources.

The speaker 118 may be disposed within body 102. The speaker 118 may be configured to provide audible sounds or information within an environment surrounding apparatus 100. The speaker 118 may be configured to receive or transmit audio information from or to a consumer electronics device. The speaker 118 may include one or more of an audio transducer, a vibrational speaker, and/or other speakers. A vibrational speaker may be configured to transmit physical vibrations through apparatus 100 to the lamp or light fixture such that audible sounds are emitted from vibrations of the lamp or light fixture.

The wireless communications device 120 may be disposed within body 102. The wireless communications device 120 may be configured to receive and/or transmit information to the consumer electronics device. The wireless communications device 120 may be compatible with one or more of a Bluetooth standard, a Wi-Fi standard, asymmetric digital subscriber line network terminal (ANT or ANT+) standard, near-field standard, and/or other wireless communications standards.

The processor(s) 122 may be configured to provide information processing capabilities in apparatus 100. The processor(s) 122 may be disposed within body 102. The processor(s) 122 may be configured to execute computer program instructions. The computer program instructions may include a light power control component 124, a wireless receiver communications component 126, a lighting quality control component 128, and/or other components.

The light power control component 124 may be configured to receive instructions to switch on or off electrical power provided to light bulb socket 106 (or light source 108). The light power control component 124 may be configured to effectuate switching on or off electrical power provided to the light bulb socket. In some implementations, light power control component 124 may be configured to switch on or off electrical power provided to light bulb socket 106 (or light source 108) in response to an alarm clock (not depicted) reaching a designated time. The alarm clock may be disposed within body 102, within the consumer electronics device, and/or at another location. In some implementations, the alarm clock is integrated with processor(s) 122.

The wireless receiver communications component 126 may be configured to receive and/or transmit information via a wireless receiver (not depicted) inserted into a given power socket 110. In some implementations, the wireless receiver may be plugged into an available power socket 110. The wireless receiver may facilitate control of apparatus 100 via one or more of a wall mounted switch, a consumer electronics device, a multi button remote, and/or other control techniques.

The lighting quality control component 128 may be configured to control an aspect of light emitted from light source 108 or a light bulb inserted into light bulb socket 106. The aspect of light may include one or more of a brightness, a color, a pattern of light, and/or other aspects of light. The lighting quality control component 128 may be configured to control the aspect of light such that the aspect changes in synchrony with music being played in an environment of apparatus 100.

The processor(s) 122 may include one or more of a digital processor, an analog processor, a digital circuit designed to process information, an analog circuit designed to process information, a state machine, and/or other mechanisms for electronically processing information. Although processor(s) 122 is shown in FIG. 1 as a single entity, this is for illustrative purposes only. In some implementations, processor(s) 122 may include a plurality of processing units. These processing units may be physically located within the same device, or processor(s) 122 may represent processing functionality of a plurality of devices operating in coordination (e.g., apparatus 100 and a personal computing device). The processor(s) 122 may be configured to execute computer program instructions including components 124, 126, 128, and/or other components. The processor(s) 122 may be configured to execute computer program instructions including components 124, 126, 128, and/or other components by software; hardware; firmware; some combination of software, hardware, and/or firmware; and/or other mechanisms for configuring processing capabilities on processor(s) 122. As used herein, the term “component” may refer to any component or set of components that perform the functionality attributed to a given component. This may include one or more physical processors during execution of processor readable instructions, the processor readable instructions, circuitry, hardware, storage media, or any other components.

It should be appreciated that although components 124, 126, and 128 are illustrated in FIG. 1 as being implemented within a single processing unit, in implementations in which processor(s) 122 includes multiple processing units, one or more of components 124, 126, and/or 128 may be implemented remotely from the other components. The description of the functionality provided by the different components 124, 126, and/or 128 described herein is for illustrative purposes, and is not intended to be limiting, as any of components 124, 126, and/or 128 may provide more or less functionality than is described. For example, one or more of components 124, 126, and/or 128 may be eliminated, and some or all of its functionality may be provided by other ones of components 124, 126, and/or 128. As another example, processor(s) 122 may be configured to execute one or more additional components of computer program instructions that may perform some or all of the functionality attributed herein to one of components 124, 126, and/or 128.

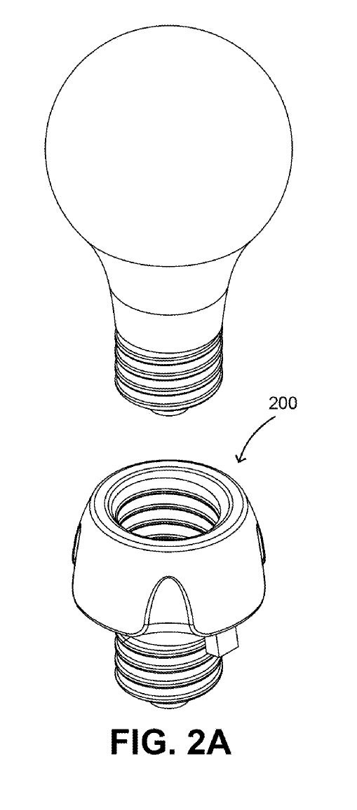

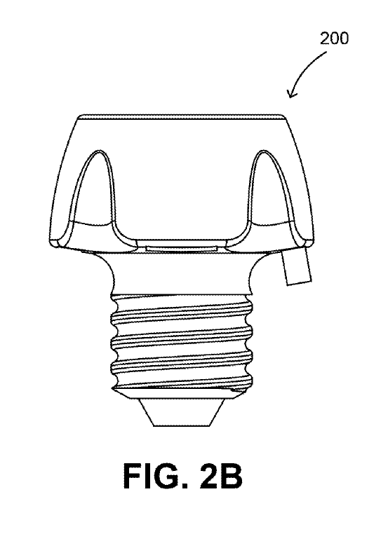

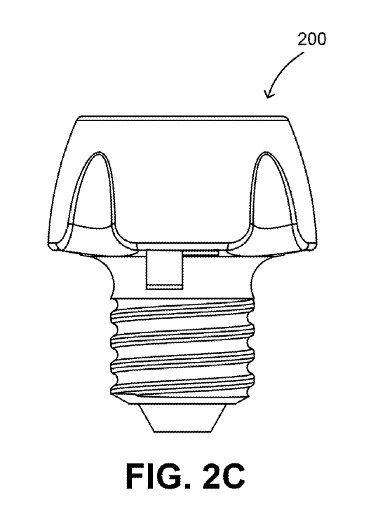

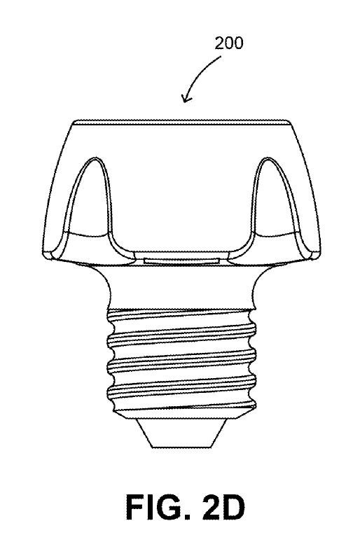

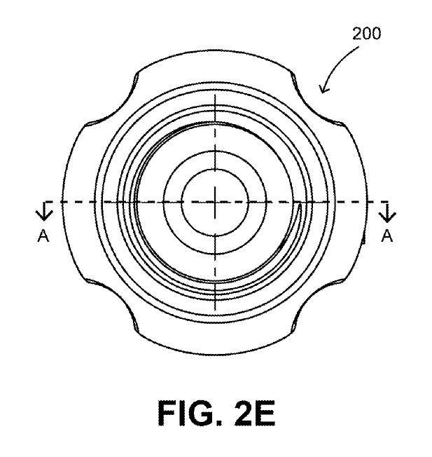

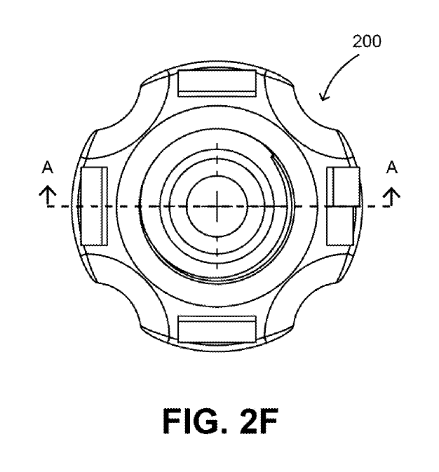

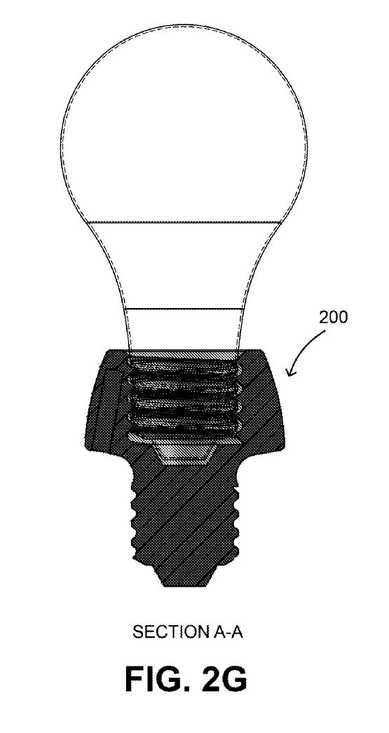

In some implementations, apparatus 100 may include a light bulb socket (e.g., light bulb socket 106) disposed on or within body 102, which may be configured to receive a light bulb. FIG. 2A illustrates a perspective view of a first exemplary implementation 200 of an apparatus configured to provide to a light bulb socket, a power socket outlet for a consumer electronics device. FIG. 2B illustrates a front elevation view of the first exemplary implementation 200 presented in FIG. 2A, which is a mirror image of a back elevation view. FIG. 2C illustrates a right-side elevation view of the first exemplary implementation 200 presented in FIG. 2A. FIG. 2D illustrates a left-side elevation view of the first exemplary implementation 200 presented in FIG. 2A. FIG. 2E illustrates a top plan view of the first exemplary implementation 200 presented in FIG. 2A. FIG. 2F illustrates a bottom plan view of the first exemplary implementation 200 presented in FIG. 2A. FIG. 2G illustrates a sectional view along Section A-A (see FIGS. 2E and 2F) of the first exemplary implementation 200 presented in FIG. 2A. FIG. 2H illustrates a sectional view along Section B-B (see FIGS. 2E and 2F) of the first exemplary implementation 200 presented in FIG. 2A.

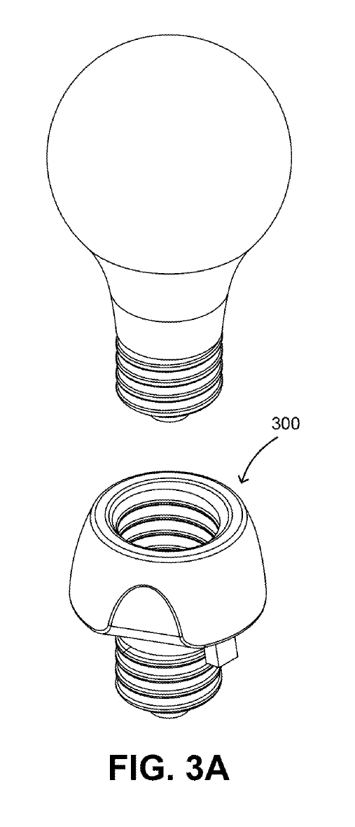

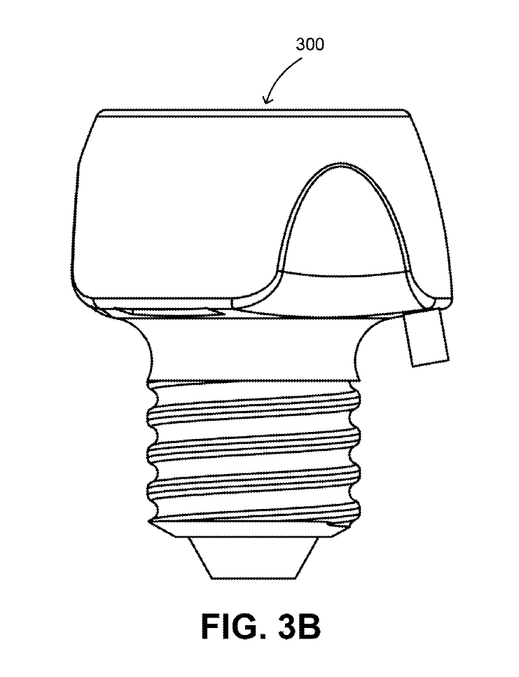

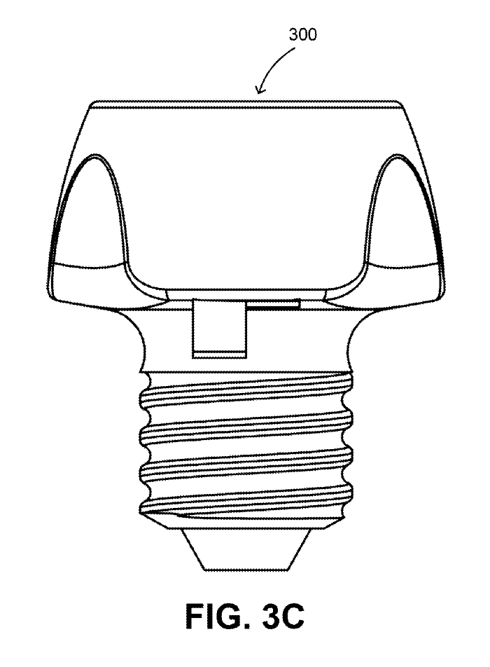

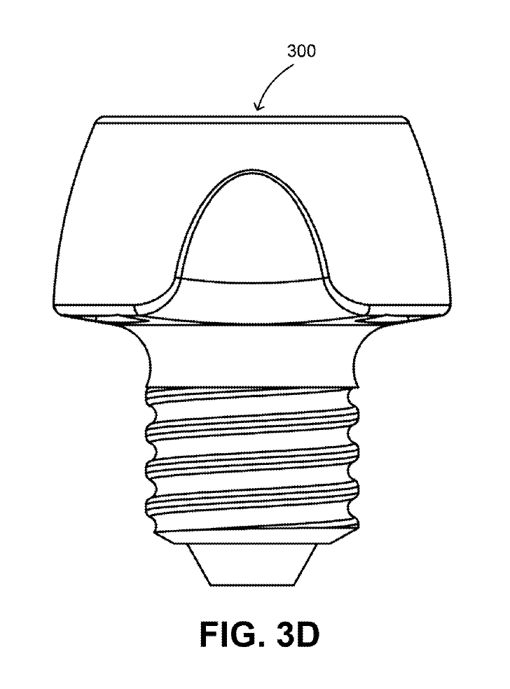

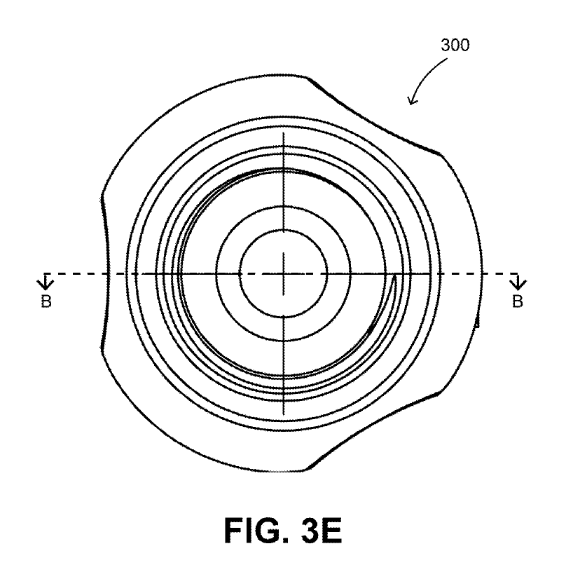

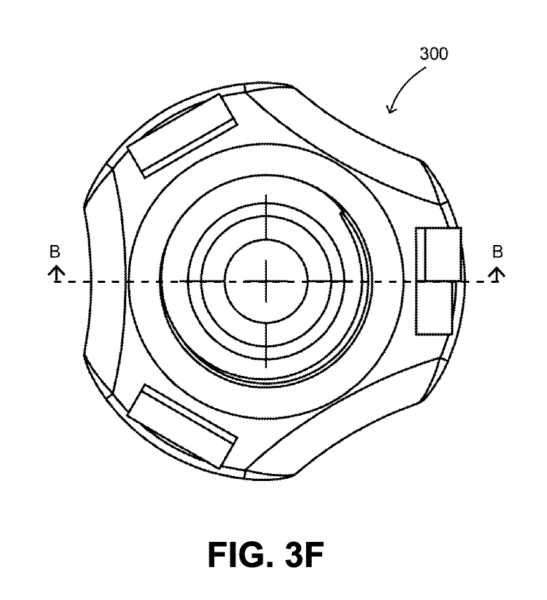

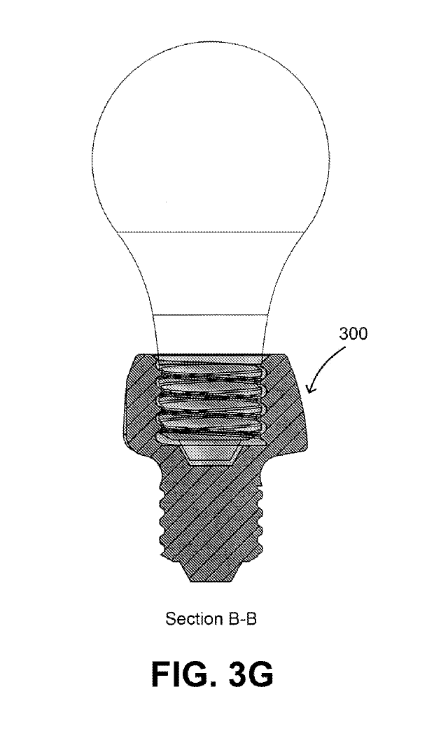

FIG. 3A illustrates a perspective view of a second exemplary implementation 300 of an apparatus configured to provide to a light bulb socket, a power socket outlet for a consumer electronics device. FIG. 3B illustrates a front elevation view of the second exemplary implementation 300 presented in FIG. 3A, which is a mirror image of a back elevation view. FIG. 3C illustrates a right-side elevation view of the second exemplary implementation 300 presented in FIG. 3A. FIG. 3D illustrates a left-side elevation view of the second exemplary implementation 300 presented in FIG. 3A. FIG. 3E illustrates a top plan view of the second exemplary implementation 300 presented in FIG. 3A. FIG. 3F illustrates a bottom plan view of the second exemplary implementation 300 presented in FIG. 3A.

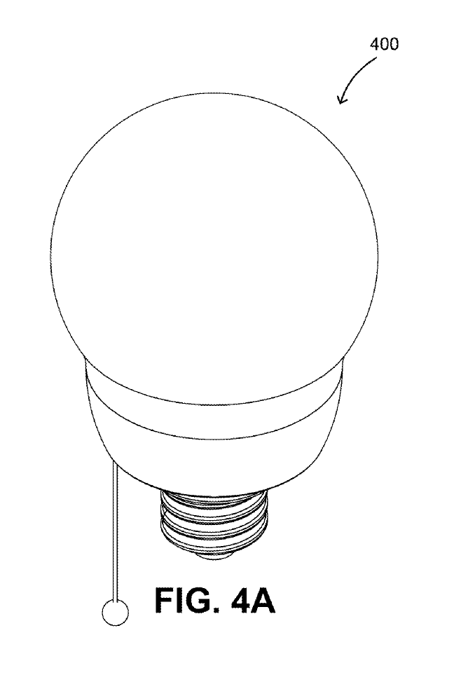

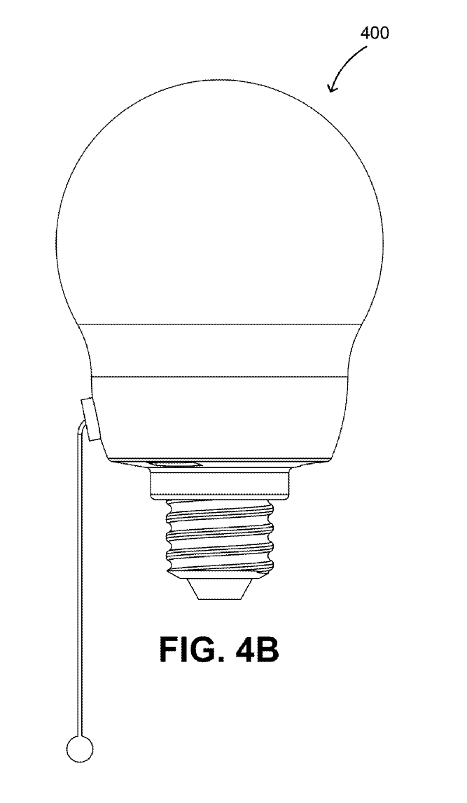

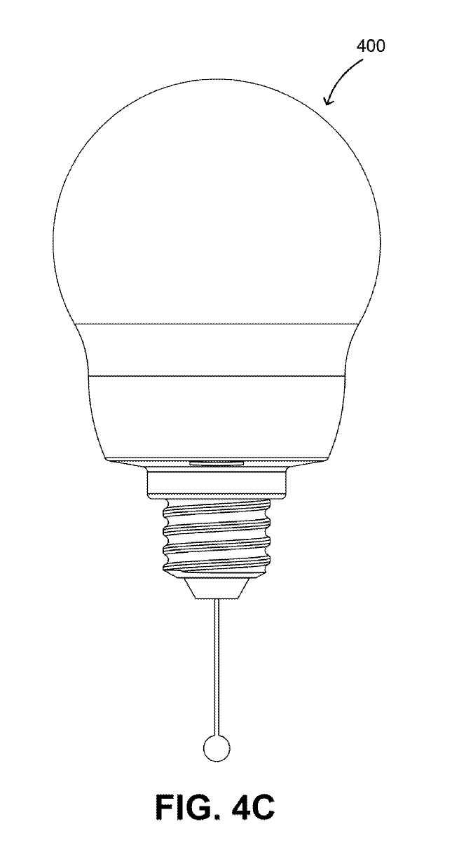

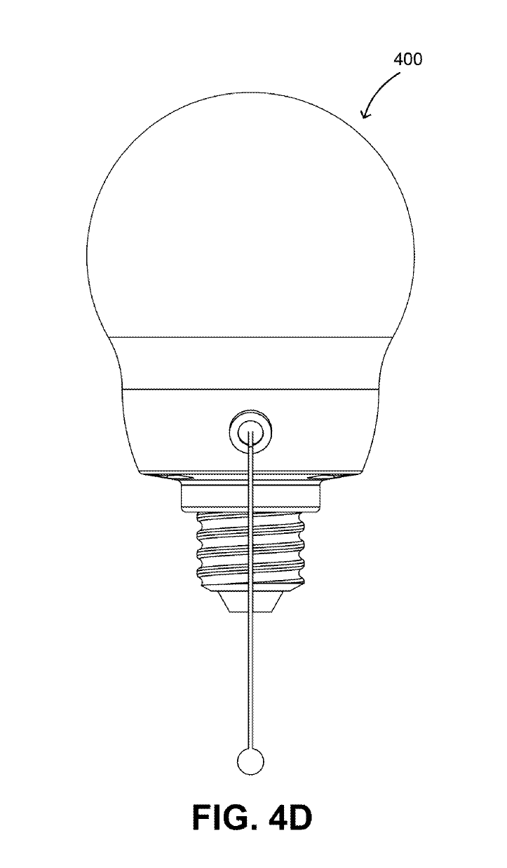

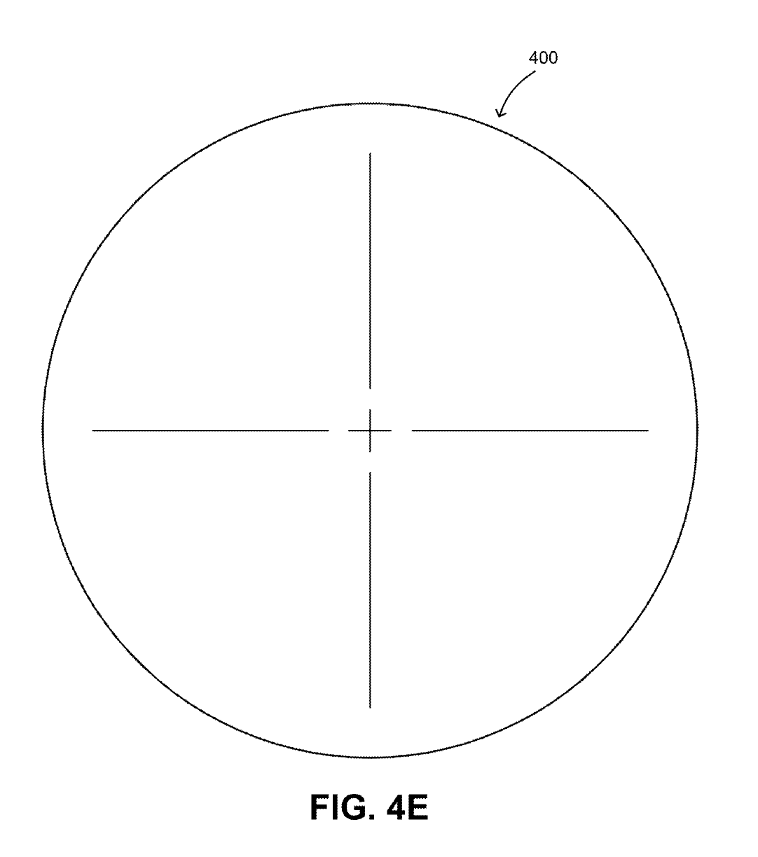

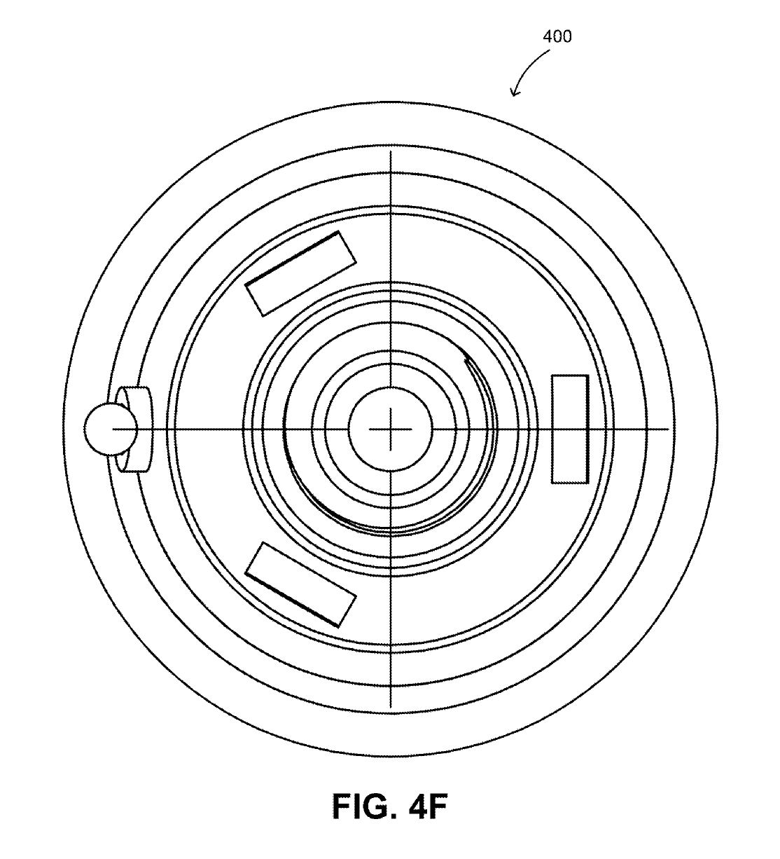

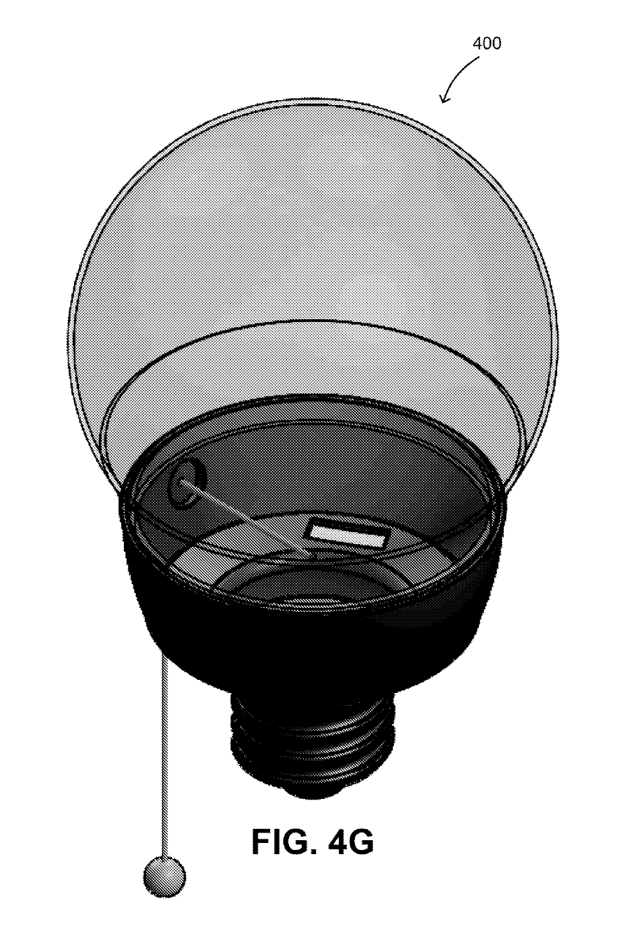

In some implementations, apparatus 100 may include a light source (e.g., light source 108) disposed on body 102 and integrated with body 102 as a singular object. FIG. 4A illustrates a perspective view of a third exemplary implementation 400 of an apparatus configured to provide to a light bulb socket, a power socket outlet for a consumer electronics device. FIG. 4B illustrates a front elevation view of the third exemplary implementation 400 presented in FIG. 4A, which is a mirror image of a back elevation view. FIG. 4C illustrates a right-side elevation view of the third exemplary implementation 400 presented in FIG. 4A. FIG. 4D illustrates a left-side elevation view of the third exemplary implementation 400 presented in FIG. 4A. FIG. 4E illustrates a top plan view of the third exemplary implementation 400 presented in FIG. 4A. FIG. 4F illustrates a bottom plan view of the third exemplary implementation 400 presented in FIG. 4A. FIG. 4G illustrates a perspective view of the third exemplary implementation 400 presented in FIG. 4A with some portions being shown as transparent.

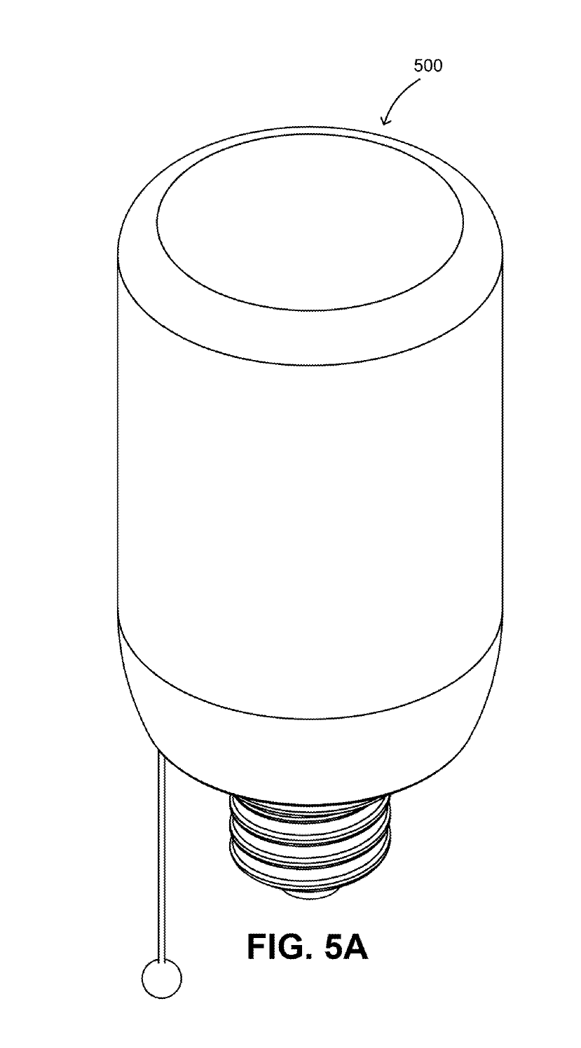

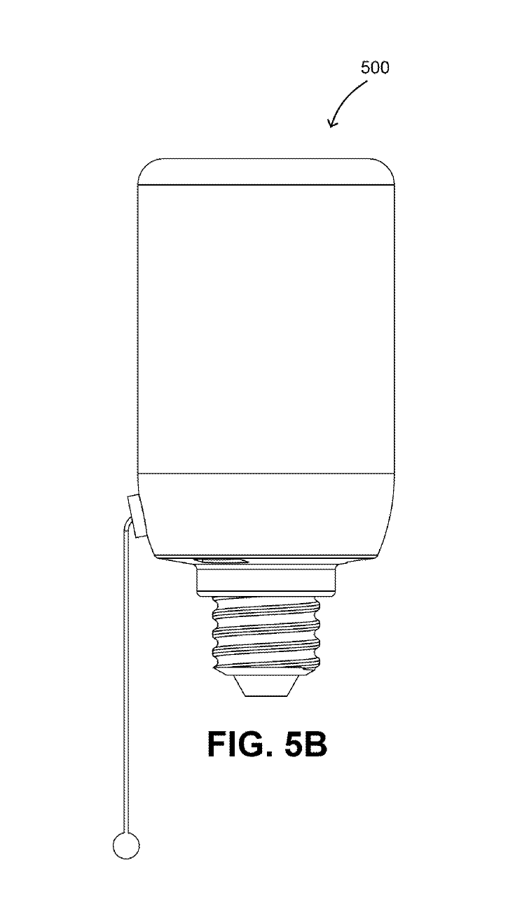

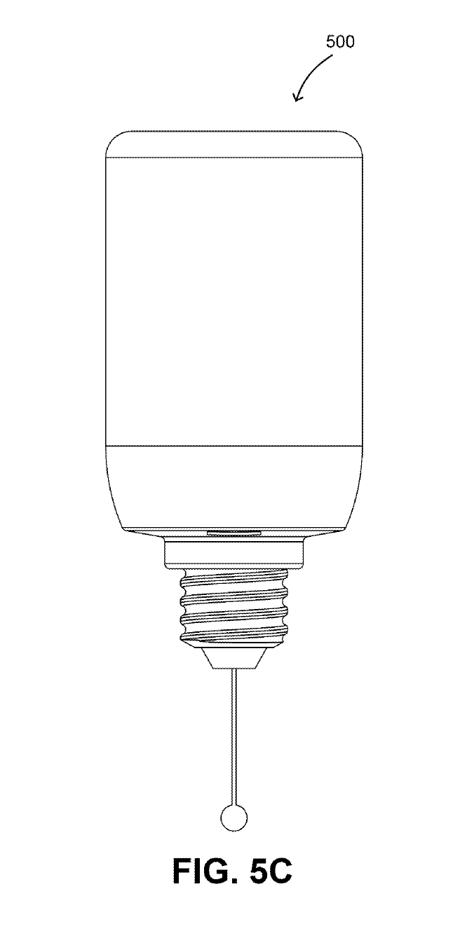

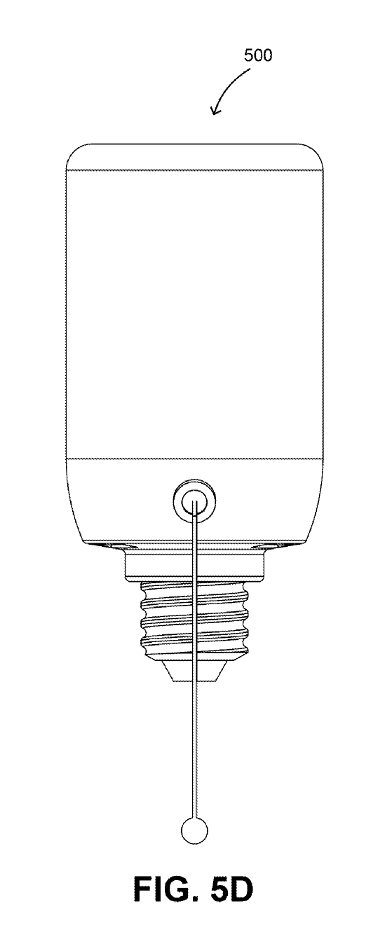

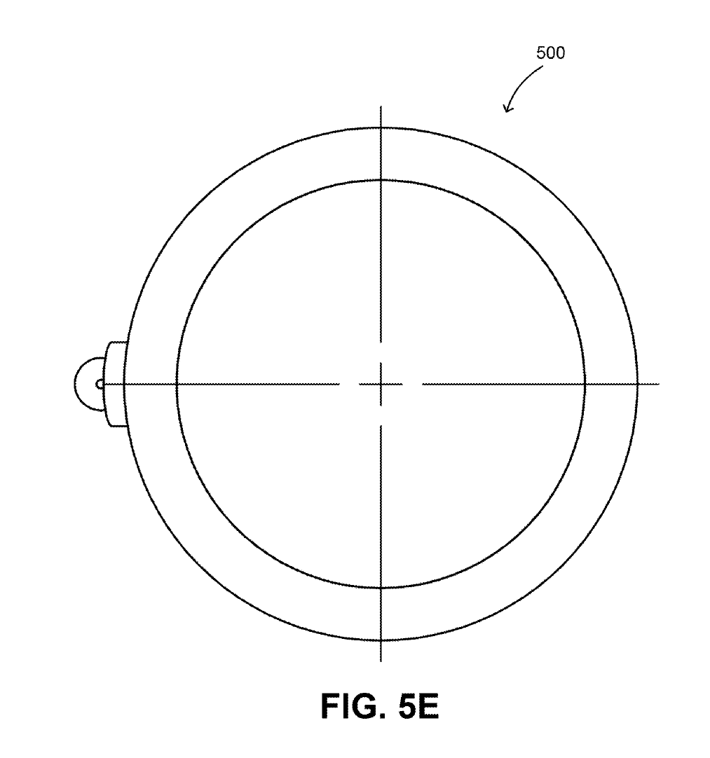

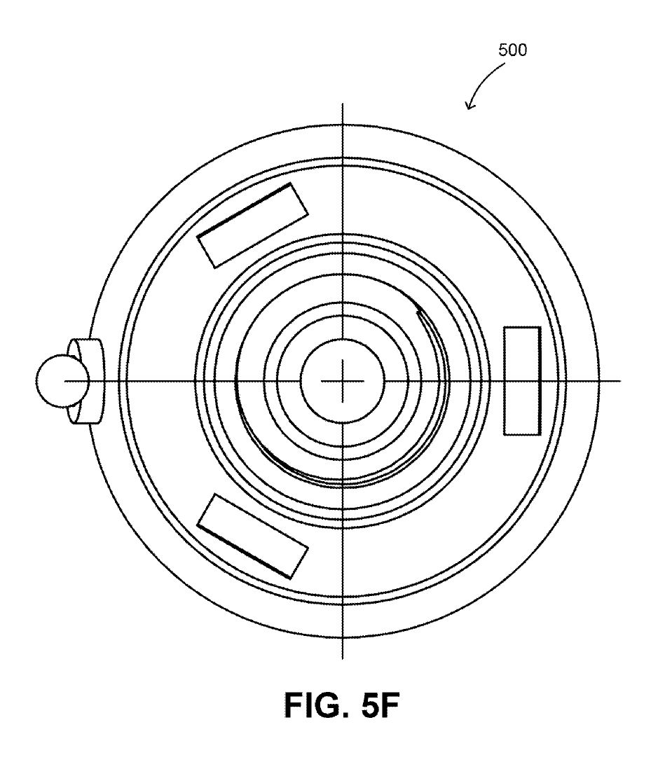

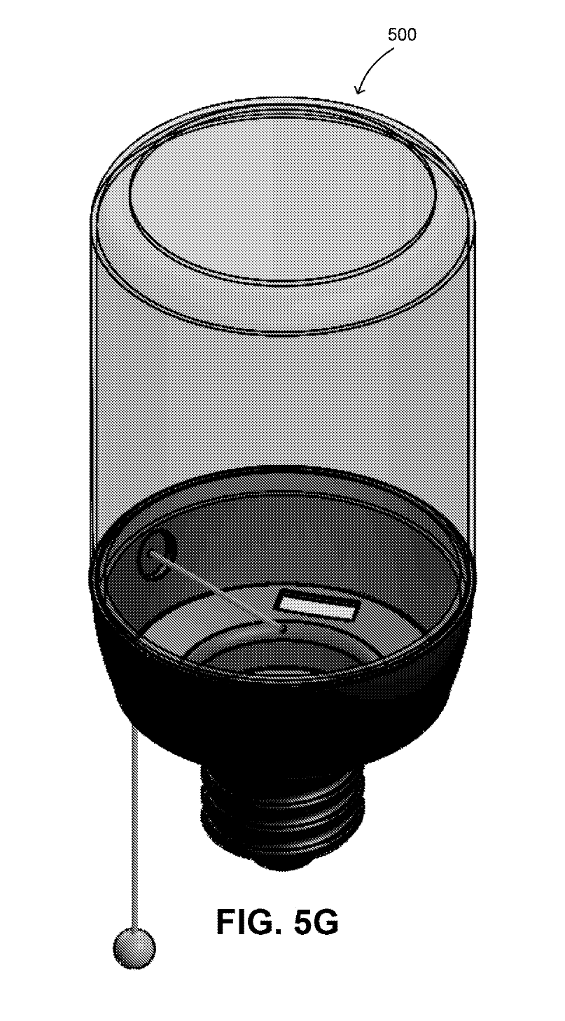

FIG. 5A illustrates a perspective view of a fourth exemplary implementation 500 of an apparatus configured to provide to a light bulb socket, a power socket outlet for a consumer electronics device. FIG. 5B illustrates a front elevation view of the fourth exemplary implementation 500 presented in FIG. 5A, which is a mirror image of a back elevation view. FIG. 5C illustrates a right-side elevation view of the fourth exemplary implementation 500 presented in FIG. 5A. FIG. 5D illustrates a left-side elevation view of the fourth exemplary implementation 500 presented in FIG. 5A. FIG. 5E illustrates a top plan view of the fourth exemplary implementation 500 presented in FIG. 5A. FIG. 5F illustrates a bottom plan view of the fourth exemplary implementation 500 presented in FIG. 5A. FIG. 5G illustrates a perspective view of the fourth exemplary implementation 500 presented in FIG. 5A with some portions being shown as transparent.

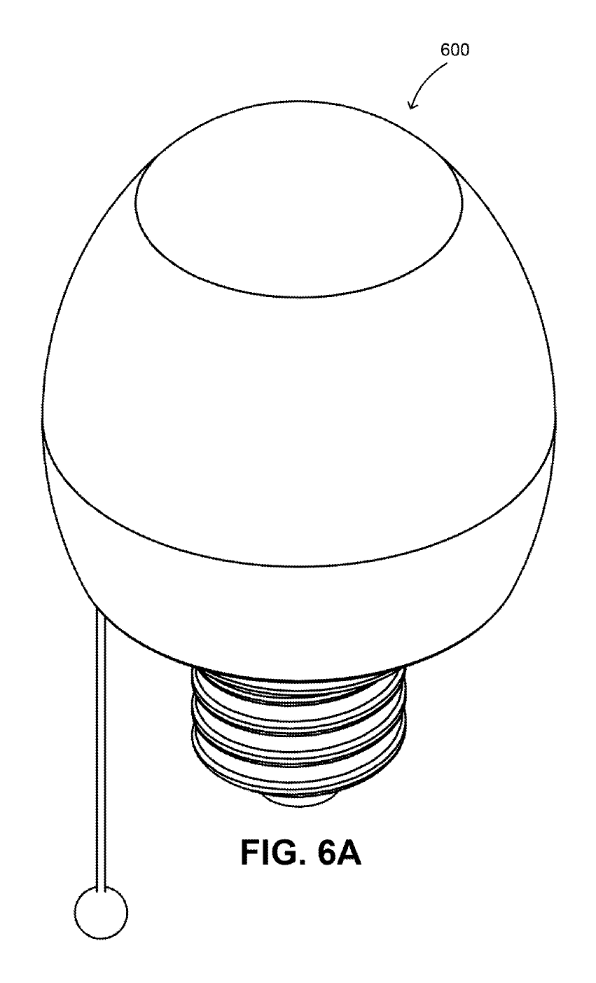

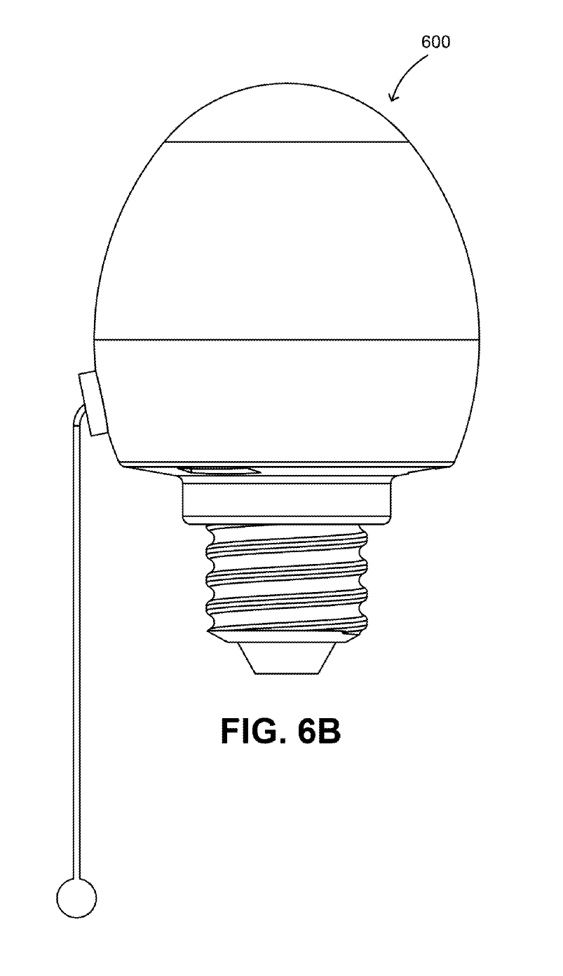

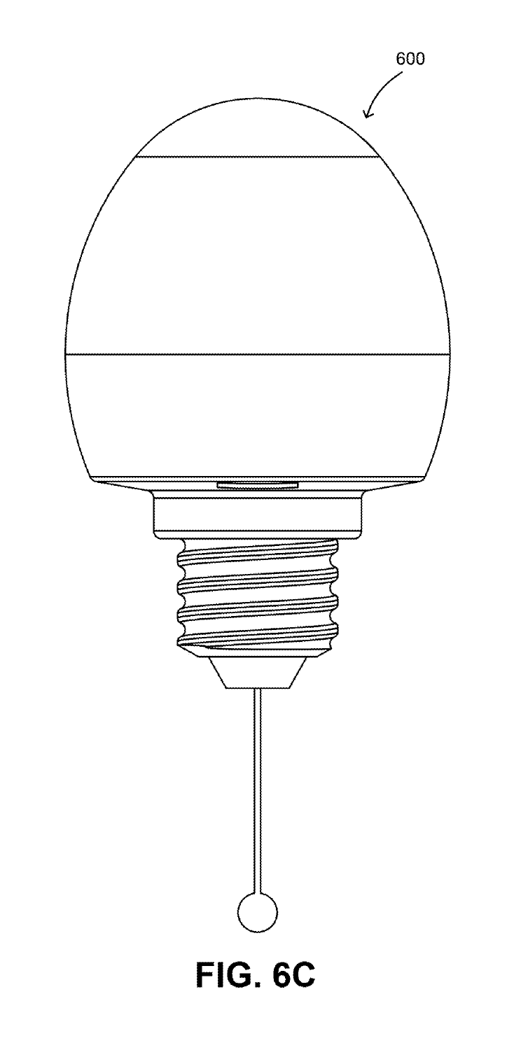

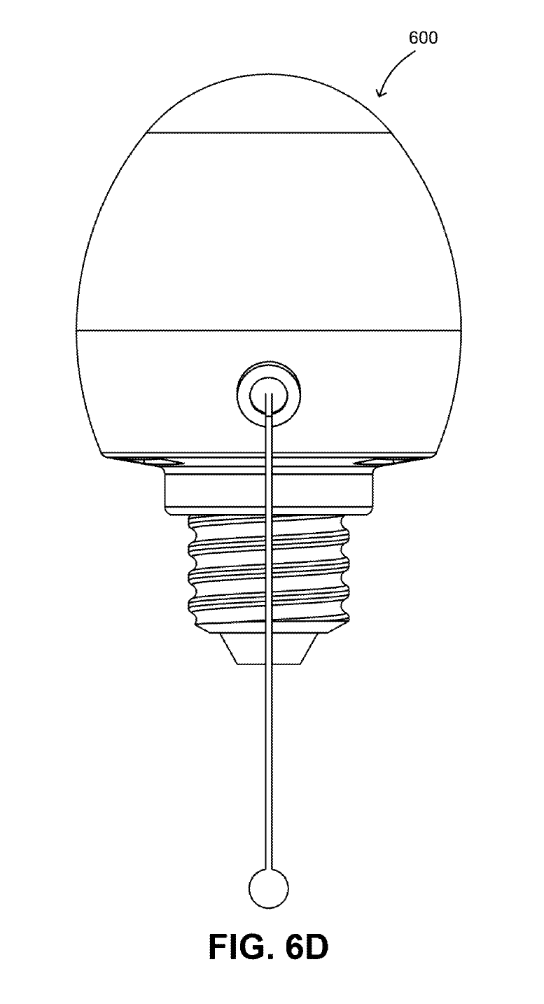

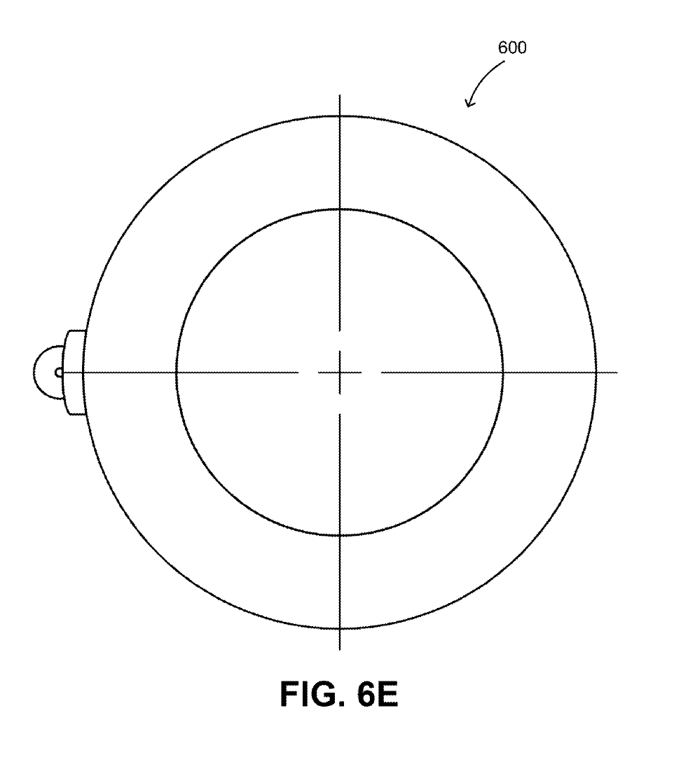

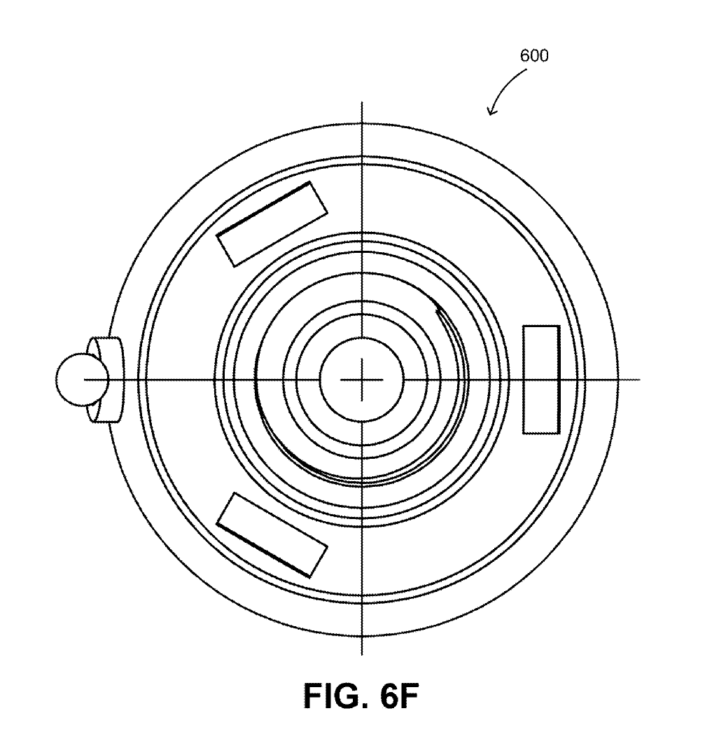

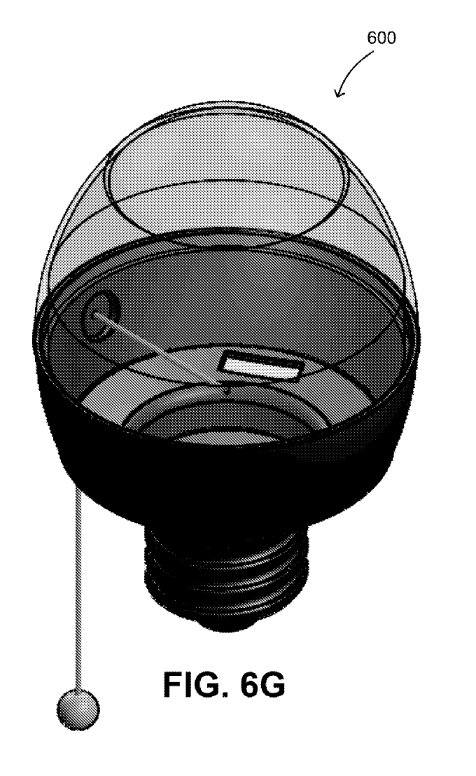

FIG. 6A illustrates a perspective view of a fifth exemplary implementation 600 of an apparatus configured to provide to a light bulb socket, a power socket outlet for a consumer electronics device. FIG. 6B illustrates a front elevation view of the fifth exemplary implementation 600 presented in FIG. 6A, which is a mirror image of a back elevation view. FIG. 6C illustrates a right-side elevation view of the fifth exemplary implementation 600 presented in FIG. 6A. FIG. 6D illustrates a left-side elevation view of the fifth exemplary implementation 600 presented in FIG. 6A. FIG. 6E illustrates a top plan view of the fifth exemplary implementation 600 presented in FIG. 6A. FIG. 6F illustrates a bottom plan view of the fifth exemplary implementation 600 presented in FIG. 6A. FIG. 6G illustrates a perspective view of the fifth exemplary implementation 600 presented in FIG. 6A with some portions being shown as transparent.

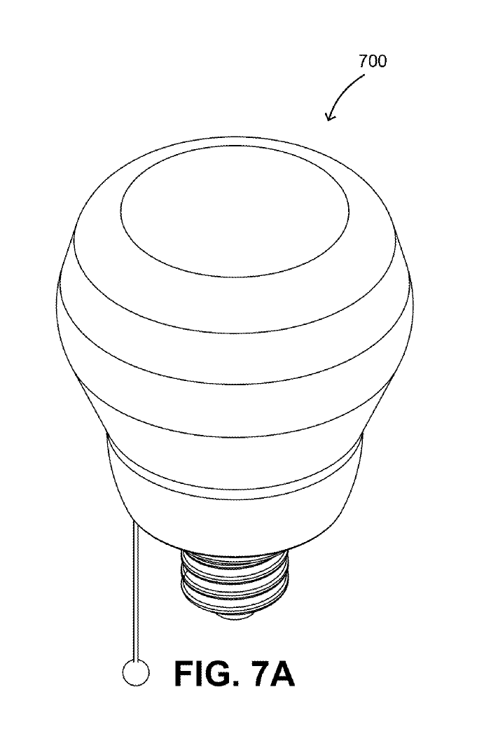

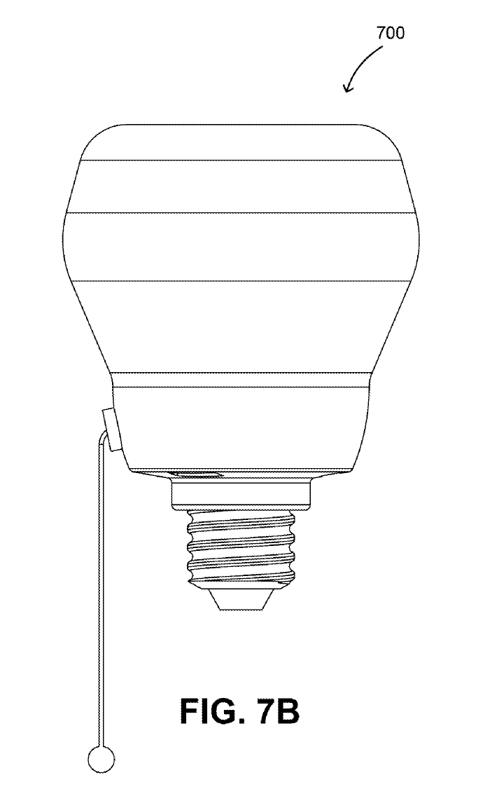

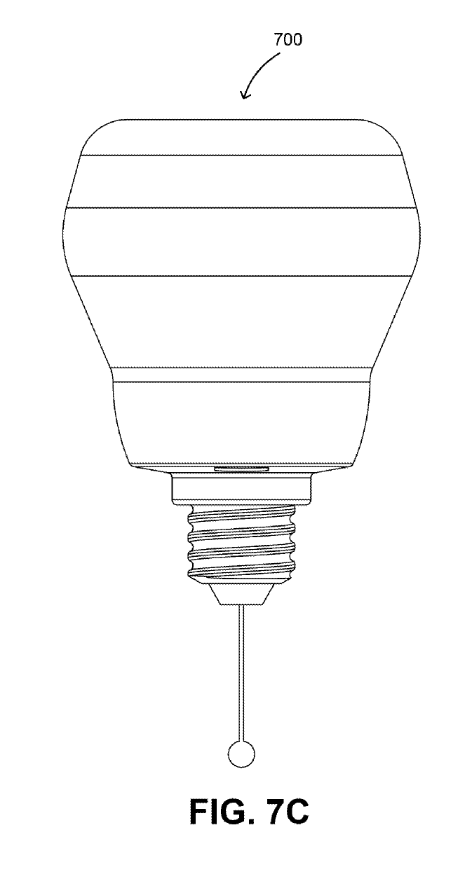

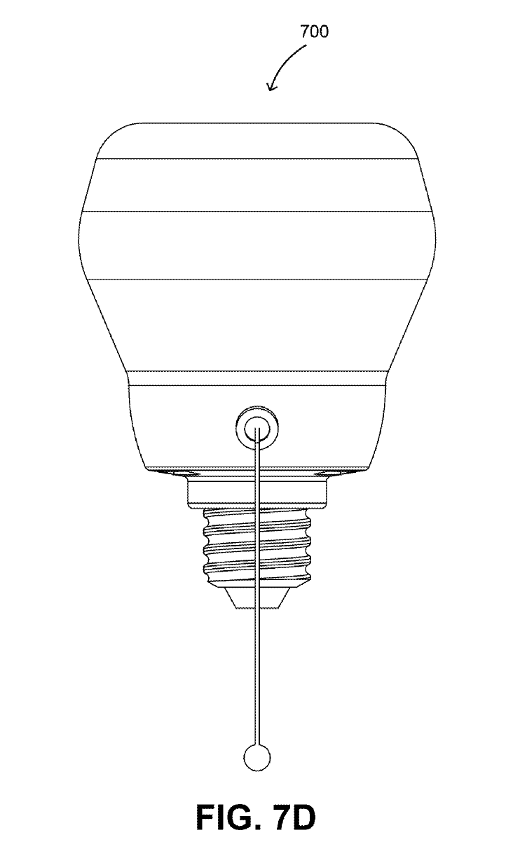

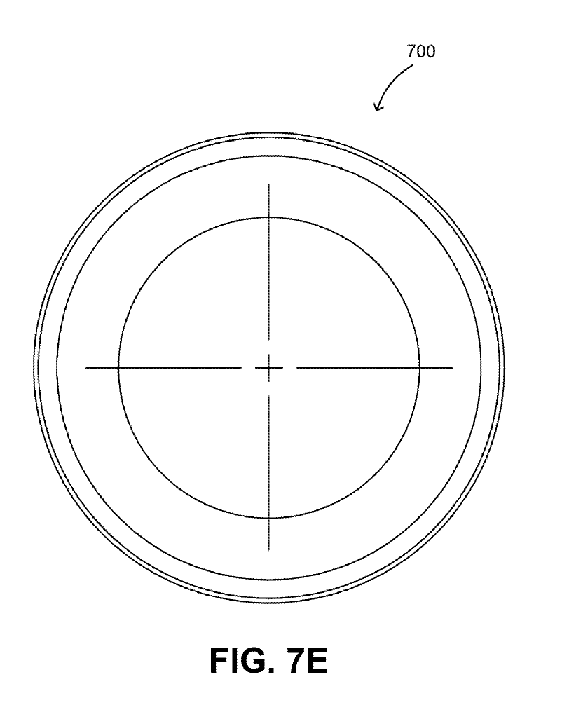

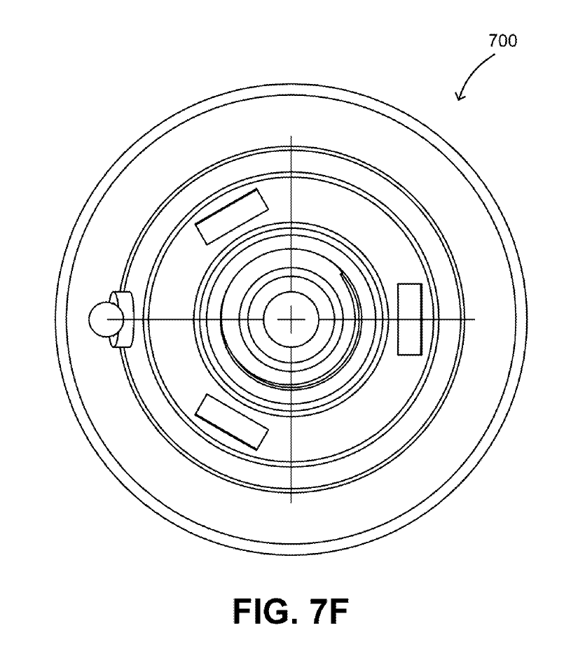

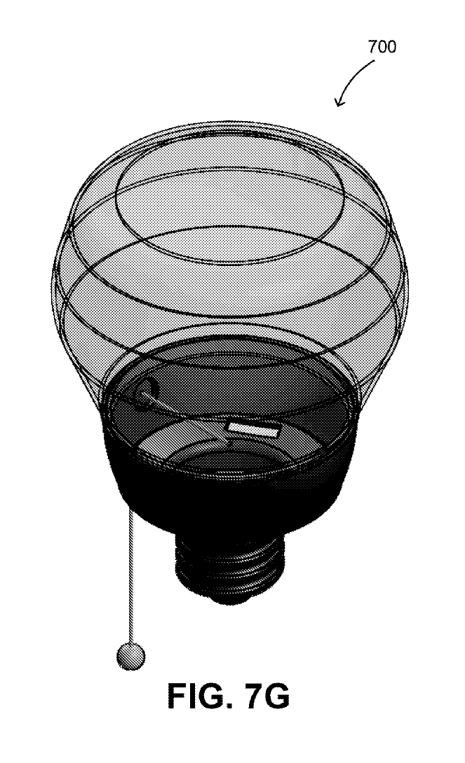

FIG. 7A illustrates a perspective view of a sixth exemplary implementation 700 of an apparatus configured to provide to a light bulb socket, a power socket outlet for a consumer electronics device. FIG. 7B illustrates a front elevation view of the sixth exemplary implementation 700 presented in FIG. 7A, which is a mirror image of a back elevation view. FIG. 7C illustrates a right-side elevation view of the sixth exemplary implementation 700 presented in FIG. 7A. FIG. 7D illustrates a left-side elevation view of the sixth exemplary implementation 700 presented in FIG. 7A. FIG. 7E illustrates a top plan view of the sixth exemplary implementation 700 presented in FIG. 7A. FIG. 7F illustrates a bottom plan view of the sixth exemplary implementation 700 presented in FIG. 7A. FIG. 7G illustrates a perspective view of the sixth exemplary implementation 700 presented in FIG. 7A with some portions being shown as transparent.

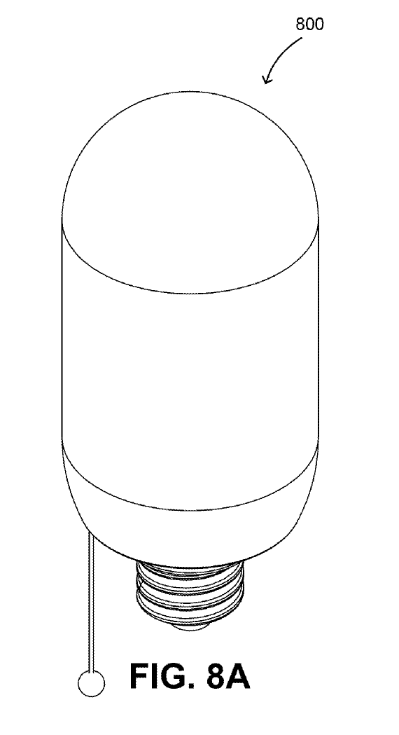

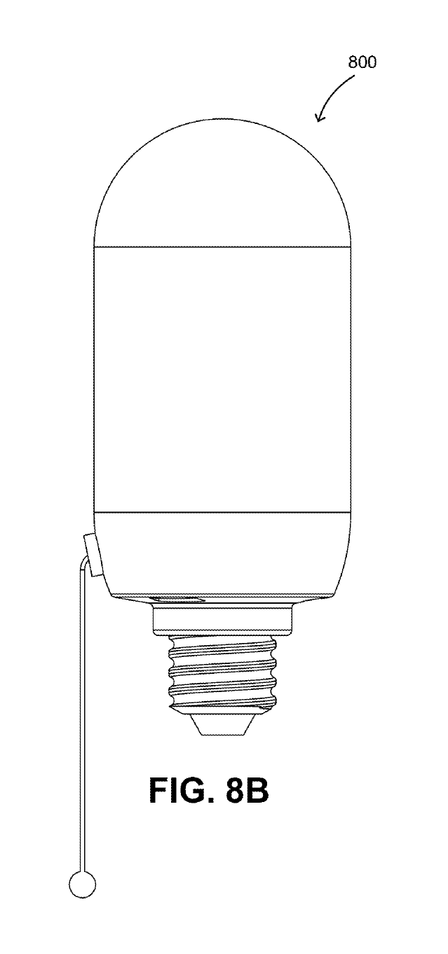

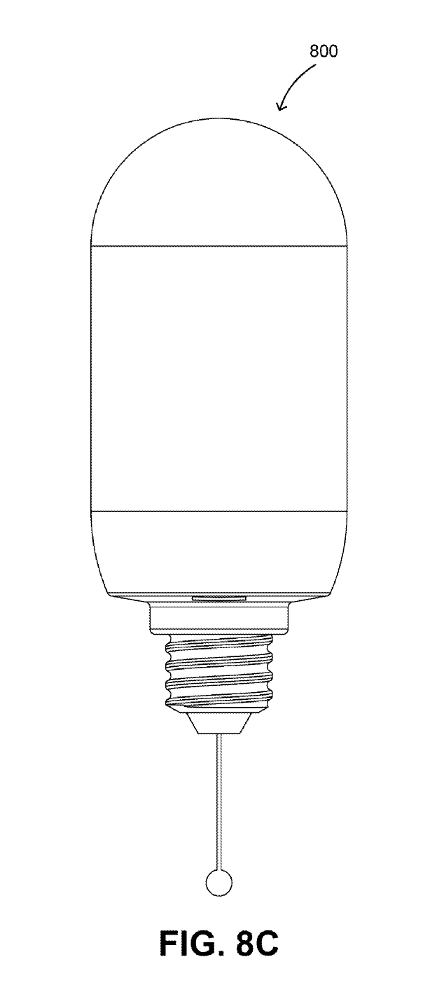

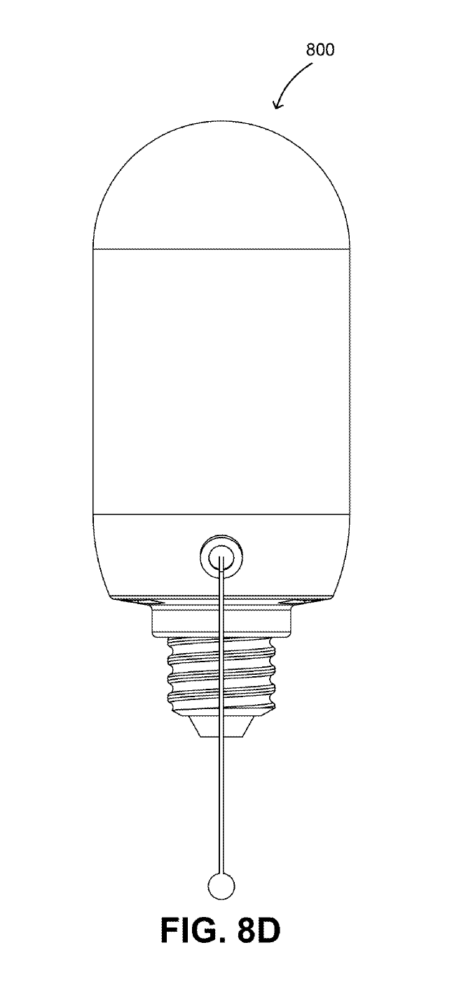

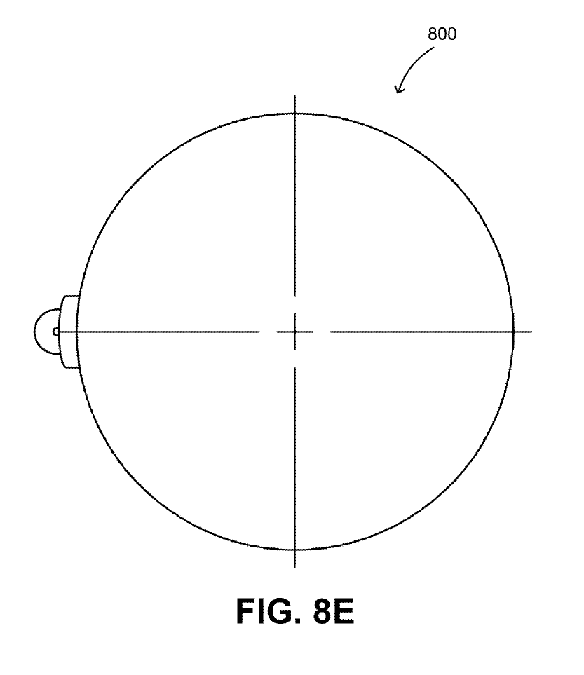

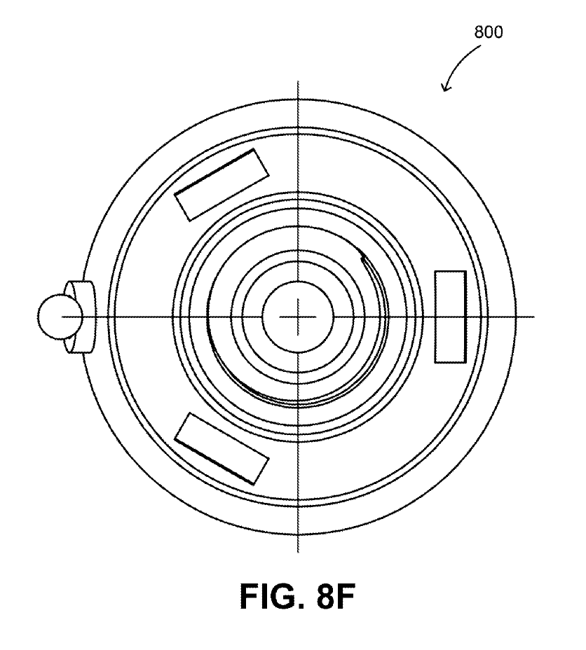

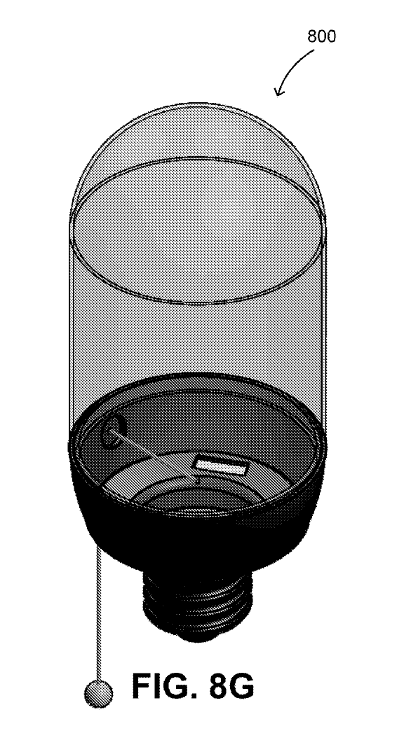

FIG. 8A illustrates a perspective view of a seventh exemplary implementation 800 of an apparatus configured to provide to a light bulb socket, a power socket outlet for a consumer electronics device. FIG. 8B illustrates a front elevation view of the seventh exemplary implementation 800 presented in FIG. 8A, which is a mirror image of a back elevation view. FIG. 8C illustrates a right-side elevation view of the seventh exemplary implementation 800 presented in FIG. 8A. FIG. 8D illustrates a left-side elevation view of the seventh exemplary implementation 800 presented in FIG. 8A. FIG. 8E illustrates a top plan view of the seventh exemplary implementation 800 presented in FIG. 8A. FIG. 8F illustrates a bottom plan view of the seventh exemplary implementation 800 presented in FIG. 8A. FIG. 8G illustrates a perspective view of the seventh exemplary implementation 800 presented in FIG. 8A with some portions being shown as transparent.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. An apparatus comprising:
a body formed of an electrically insulating material;
a connector base disposed on the body, the connector base being configured to be inserted into a socket of a lamp or light fixture to provide an electrical connection between the apparatus and the lamp or light fixture;
a light source irremovably coupled with the body, the light source being configured such that electrical power from the lamp or light fixtures is provided to the light source; and
one or more power sockets disposed on or within the body including a first power socket, the first power socket being configured to receive a plug electrically coupled to a coupling consumer electronics device such that electrical power from the lamp or light fixture is provided to the consumer electronics device,
wherein the light source and the body form a singular object.

2. The apparatus of claim 1, wherein the electrically insulating material of the body is a ceramic material or polymeric material.

3. The apparatus of claim 1, wherein the first power socket is a socket selected from the group consisting of a standard size USB socket, a mini size USB socket, a micro size USB socket, a FireWire, and a Thunderbolt socket.

4. The apparatus of claim 1, further comprising a switching mechanism configured to switch on and off electrical power provided to the light source while electrical power to the first power socket is maintained on.

5. The apparatus of claim 4, wherein the switching mechanism is selected from the group consisting of a pull-chain switch, a twist knob switch, a push button switch, a toggle switch, a rocker switch, a wireless switch, and a touch-sensitive switch.

6. The apparatus of claim 4, wherein the switching mechanism is communicatively coupled with a wall switch such that actuating the wall switch switches on and off electrical power provided to the light bulb socket while electrical power to the first power socket is maintained on.

7. The apparatus of claim 6, wherein the communicative coupling between the switching mechanism of the apparatus and the wall switch includes one or both of a wireless connection or a wired connection.

8. The apparatus of claim 1, further comprising a rectifier disposed within the body, the rectifier being configured to transform alternating current received from the lamp or light fixture to direct current such that direct current is provided to the first power socket.

9. The apparatus of claim 1, further comprising a transformer disposed within the body, the transformer being configured to step down a voltage received from the lamp or light fixture such that a reduced voltage is provided to the first power socket.

10. The apparatus of claim 1, further comprising a speaker disposed within the body, the speaker being configured to effectuate emission of audible sounds within an environment surrounding the apparatus.

11. The apparatus of claim 10, wherein the speaker is configured to receive audio information from the consumer electronics device.

12. The apparatus of claim 1, further comprising a wireless communications device disposed within the body, the wireless communications device being configured to receive and/or transmit information to consumer electronics device.

13. The apparatus of claim 12, wherein the wireless communications device is compatible with one or more of a Bluetooth standard, a Wi-Fi standard, an ANT or ANT+ standard, and/or a near-field standard.

14. The apparatus of claim 1, further comprising a power source, the power source being configured to store electrical power and provide electrical power to one or more components of the apparatus.

15. The apparatus of claim 1, further comprising one or more processors disposed within the body, the one or more processors being configured by machine-readable instructions to:
receive instructions to switch on or off electrical power provided to the light source; and
effectuate switching on or off electrical power provided to the light source.

16. The apparatus of claim 15, further comprising an alarm clock communicatively coupled with the one or more processors, wherein the one or more processors are configured to effectuate switching on or off electrical power provided to the light bulb in response to the alarm clock reaching a designated time.

17. The apparatus of claim 16, wherein the alarm clock is disposed within the body of the apparatus or within the consumer electronics device.

18. The apparatus of claim 15, wherein the one or more processors are further configured by machine-readable instructions to control one or more of a brightness, a color, or a pattern of light emitted from the light source.

19. The apparatus of claim 18, wherein the one or more processors are configured to control the one or more of the brightness, the color, or the pattern of light emitted from the light source in synchrony with music being played in an environment of the apparatus.

20. The apparatus of claim 15, further comprising a wireless receiver inserted into the first power socket, wherein the one or more processors are further configured by machine-readable instructions to:
receive and/or transmit information via the wireless receiver; and
facilitate control of the apparatus via one or more of a wall mounted switch, the consumer electronics device, or a multi button remote
